(19) United States
(12) Patent Application Publication
(10) Pub. No.: US 2016/0180601 A1
(43) Pub. Date: Jun. 23, 2016

(54) APPARATUS AND METHOD FOR PRE-VISUALIZING TEXT-BASED PERFORMANCE

(71) Applicant: ELECTRONICS AND TELECOMMUNICATIONS RESEARCH INSTITUTE, Daejeon (KR)

(72) Inventors: Su Ran PARK, Daejeon (KR); Hyun Bin KIM, Seongnam-si (KR); Seong Won RYU, Daejeon (KR); Ki Suk LEE, Daejeon (KR)

(21) Appl. No.: 14/947,550

(22) Filed: Nov. 20, 2015

(30) Foreign Application Priority Data
Dec. 17, 2014 (KR) 10-2014-0182452

(51) Int. Cl. G06T 19/20; G06F 3/16; G06F 17/27; G06T 19/00

(52) U.S. Cl. CPC G06T 19/20; G06T 19/006; G06F 3/167; G06F 17/2705

(57) ABSTRACT

An apparatus and method for pre-visualizing a performance stage using text and performing simulation thereon. The apparatus for pre-visualizing text-based performance includes a text parsing unit configured to parse received text and output a result of text parsing, a visual information extracting and converting unit configured to receive the result of text parsing, extract visual information, and convert the extracted visual information, a virtual space generating and object disposing unit configured to dispose an object in a virtual space generated by using the converted visual information, a virtual performance stage output unit configured to output a virtual performance stage including the object, and a simulation unit configured to perform performance simulation on the virtual performance stage upon receiving a command.

### CROSS-REFERENCE TO RELATED APPLICATIONS

This application claims priority under 35 U.S.C. §119 to Korean Patent Application No. 10-2014-0182452, filed on Dec. 17, 2014, the disclosure of which is incorporated herein by reference in its entirety.

### BACKGROUND OF THE INVENTION

1. Field of the Invention

The present invention relates to an apparatus and method for pre-visualizing a performance stage using text and performing simulation thereon.

2. Description of Related Art

Pre-visualization refers to an advanced work including a making process similar to actual making on the basis of a story board by using modeling data obtained by simplifying a full story in movie or 3D animation, before a regular work, thereby allowing for negotiation regarding making (or production) with a production company and tuning budget.

As pre-visualization techniques have advanced, various model databases and authoring tools have been developed and extendedly applied to various fields such as architecture, exhibition, broadcasting, education, and simulation, as well as to movie and animation.

Performance such as plays, music, and dance in open places involves a great amount of cost due to location renting for rehearsal, stage production, or performer casting, and thus, visualization of physical performance and simulation thereof are extremely limited.

Thus, a technique allowing for visually generating stage performance similar to actual stage performance and simulation thereof by using a scheme having high user access and high immediacy is required.

### SUMMARY

Accordingly, the present invention provides an apparatus and method for pre-visualizing text-based performance, which pre-visualize virtual stage performance using text and simulate the visualized stage performance.

In one general aspect, an apparatus for pre-visualizing text-based performance includes: a text parsing unit configured to parse received text and output a result of text parsing; a visual information extracting and converting unit configured to receive the result of text parsing, extract visual information, and convert the extracted visual information; a virtual space generating and object disposing unit configured to dispose an object in a virtual space generated by using the converted visual information; a virtual performance stage output unit configured to output a virtual performance stage including the object; and a simulation unit configured to perform performance simulation on the virtual performance stage upon receiving a command.

In another general aspect, a method for pre-visualizing text-based performance includes: parsing received text and outputting a result of text parsing, extracting visual information by using the result of text parsing, and converting the extracted visual information into a visualization script language; generating a virtual space and disposing an object; and outputting a virtual performance stage including the object, and performing performance simulation.

Other features and aspects will be apparent from the following detailed description, the drawings, and the claims.

### BRIEF DESCRIPTION OF THE DRAWINGS

FIG. 1 is a block diagram illustrating an apparatus for pre-visualizing text-based performance according to an embodiment of the present invention.

FIG. 2 is a view illustrating a virtual performance stage simulation screen according to an embodiment of the present invention.

FIG. 3 is a flow chart illustrating a method for pre-visualizing text-based performance according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter.

The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

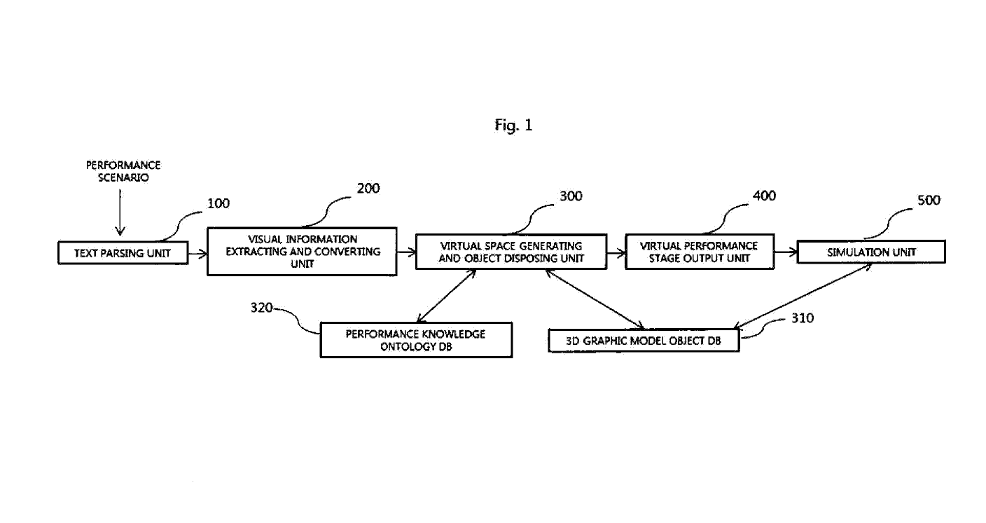

FIG. 1 is a block diagram illustrating an apparatus for pre-visualizing text-based performance according to an embodiment of the present invention.

The apparatus for pre-visualizing text-based performance according to an embodiment of the present invention includes a text parsing unit 100 parsing received text and outputting a text parsing result, a visual information extracting and converting unit 200 receiving the text parsing result, extracting visual information, and converting the extracted visual information, a virtual space generating and object disposing unit 300 disposing objects in a virtual space generated by using the converted visual information, a virtual performance stage output unit 400 outputting a virtual performance stage including the objects, and a simulation unit 500 performing performance simulation on a virtual performance stage upon receiving a command.

The text parsing unit 100 according to an embodiment of the present invention receives script or performance scenario text and parses the received script or performance scenario text.

Here, the text parsing unit 100 parses the received text through natural language processing.

Upon receiving the parsing result from the text parsing unit 100, the visual information extracting and converting unit 200 according to an embodiment of the present invention extracts visual information such as stage configuration scenes, objects, or object layout information, and converts the extracted visual information into a visualization script language.

The virtual space generating and object disposing unit 300 according to an embodiment of the present invention automatically generates at least one of a ground and lighting by using a predefined virtual space template to generate a virtual environment space.

Also, the virtual space generating and object disposing unit 300 disposes objects and major characters of scenes according to a specific stage management in the generated virtual space.

Here, the virtual space generating and object disposing unit 300 retrieves data matched to the converted visualization script language from a performance knowledge ontology database (DB) 320 and a 3D graphic model object DB 310, and disposes a virtual stage and characters.

That is, the virtual space generating and object disposing unit 300 retrieves object layout and virtual character matched to the visualization script language of the parsed visual information from the 3D graphic model object DB 310, and arranges performance of scenes with reference to knowledge-based in formation stored in the performance knowledge ontology DB 320.

Ontology is defined as formal and explicit specification regarding shared conceptualization.

That is, ontology may be understood as a dictionary including words and relationships, in which words related to a specific domain are hierarchically expressed and a rule of interference for expanding the words is included.

Thus, Web-based knowledge may be process or knowledge may be shared between application programs or reused by the ontology.

The ontology is the most central concept of a semantic Web application, and a language defining a schema or a syntax structure to express it is called an ontology language.

The virtual space generating and object disposing unit 300 according to an embodiment of the present invention disposes scenes with reference to knowledge-based information of the performance knowledge ontology DB 320, even a layman, rather than a performance producer or a director, may be able to perform performance pre-visualization in a virtual environment from text as a script or scenario.

The virtual performance stage output unit 400 according to an embodiment of the present invention inputs layout information of a virtual stage and characters to the virtual space received from the virtual space generating and object disposing unit 300 to generate a virtual performance stage, and outputs the generated virtual performance stage.

Also, the simulation, unit 500 according to an embodiment of the present invention may change the layout of objects in scenes according to a received command, and manage the stage regarding the virtual space.

Here, when editing information is received, the simulation unit 500 according to an embodiment of the present invention retrieves information from the 3D graphic model object DB 310 matched to the editing information and edits a scene regarding the virtual performance stage, thus allowing for text-based editing.

In addition, the simulation unit 500 according to an embodiment of the present invention provides a text editor and converts editing information input in a language interface manner into a virtualization script language by using the text editor, thus editing a scene regarding the virtual performance stage.

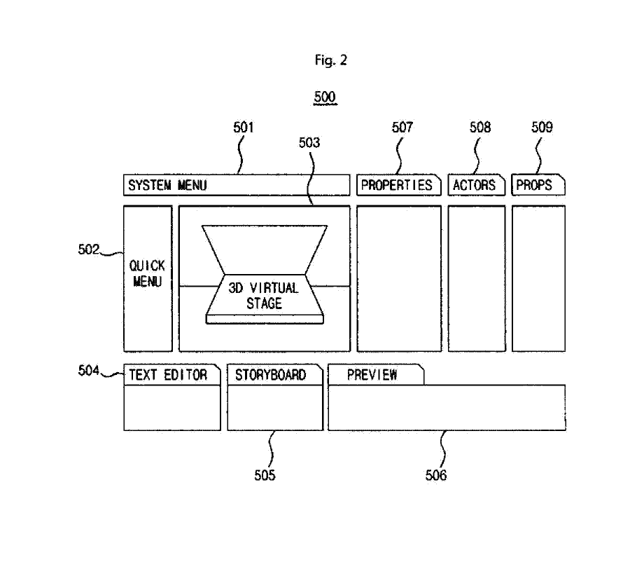

FIG. 2 is a view illustrating a configuration of a screen of the apparatus for pre-visualizing text-based performance according to an embodiment of the present invention.

As illustrated in FIG. 2, a configuration and a position of a screen 500 may be changed, and a virtual performance simulation may be performed in real time by changing parameters.

A system menu 501 is a menu tool for controlling an overall system of the apparatus for pre-visualizing text-based performance according to an embodiment of the present invention, and a quick menu 502 includes a main usage tool for performing performance visualization and simulation.

A user may view a performance visualization scene through a 3D virtual stage scene window 503 and may edit a scene using a language interface through a text editor 504.

As described above, when editing information is input using the text editor 504, the input editing information is converted into a visualization script language to perform editing on a virtual performance stage.

A story board 505 sequentially illustrates visualization images of performance according to the passage of time from start to finish, and a preview 506 outputs a scene animation or video of a finally directed virtual stage.

Properties 507 is a menu allowing properties of automatically disposed objects and a stage space to be edited, and actors 508 provide an editing function to allow a virtual character to be freely corrected so as to be optimized for performance of a virtual stage, add a new performer, or delete an existing performer.

Props 509, a list of objects included in the 3D graphic model object DB 310, provide a function to illustrate detailed display props or major tools required for stage construction, and add or correct the props or tools.

According to an embodiment of the present invention, performance may be pre-visualized by text in a virtual environment and the pre-visualized performance may be simulated, whereby even laymen, as well as a performance producer or a director, may be provided with a virtual performance stage in a visualized form.

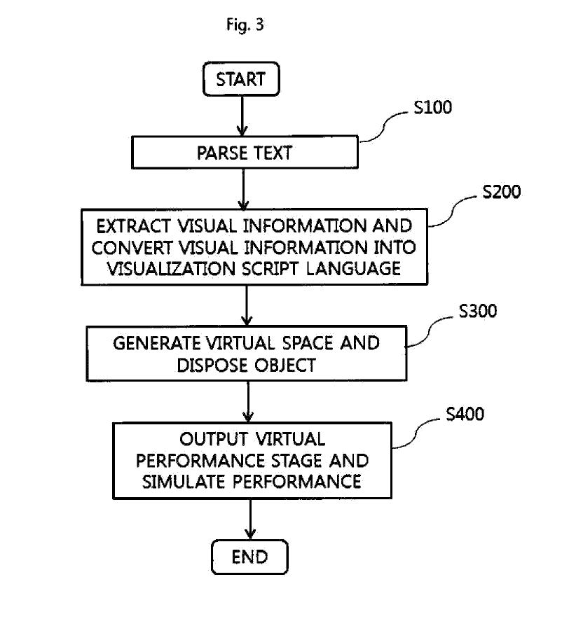

FIG. 3 is a flow chart illustrating a method for pre-visualizing text-based performance according to an embodiment of the present invention.

The method for pre-visualizing text-based performance according to an embodiment of the present invention includes parsing received text and outputting a result of text parsing (S100), extracting visual information using the result of text parsing and converting the extracted visual information into a visualization script language (S200), generating a virtual space and disposing objects (S300), and outputting a virtual performance stage including the objects and performing stage simulation (S400).

In step S100, text including information regarding scene display such as script or performance scenario, and natural language-processed so as to be parsed.

In step S200, visual information including a stage construction scene, an object, and object layout information is extracted according to the text parsing result, and the extracted visual information is converted into a visualization script language so as to be computer-readable.

In step S300, a virtual space including a ground and lighting information is generated by using a predefined space template, and data matched to the visualization script language is retrieved from a performance knowledge ontology DB and a 3D graphic model object DB and stage and character layout information is added to the virtual space.

In step S400, a layout of objects in scenes is changed according to a received command, and a virtual performance stage is directed.

Here, in step S400, editing information input in a language interface through a text editor is converted into visualization script language, and data matched to the converted visualization script language is retrieved from the 3D graphic model object DB to edit scenes of the virtual performance stage. This is the step of performing editing using the text editor illustrated in FIG. 2.

The apparatus and method for pre-visualizing text-based performance may pre-visualize performance in a virtual environment by using text, and perform simulation thereon.

Performance producers, directors, and laymen who want to visualize performance may easily check physically visualized virtual performance stage and simulate the virtual performance stage.

In addition, since a virtual performance stage is visualized by combining previously created 3D graphic model data, a process of modeling and rendering a 3D authoring tool is omitted, facilitating stage management and rehearsal in a virtual space.

The effect of the present invention is not limited to the aforesaid, but other effects not described herein will be clearly understood by those skilled in the art from descriptions above.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for pre-visualizing text-based performance, the apparatus comprising:
a text parsing unit configured to parse received text and output a result of text parsing;
a visual information extracting and converting unit configured to receive the result of text parsing, extract visual information, and convert the extracted visual information;
a virtual space generating and object disposing unit configured to dispose an object in a virtual space generated by using the converted visual information;
a virtual performance stage output unit configured to output a virtual performance stage including the object; and
a simulation unit configured to perform performance simulation on the virtual performance stage upon receiving a command.

2. The apparatus of claim 1, wherein the text parsing unit receives text regarding a scenario and performs natural language processing on the received text to parse the text.

3. The apparatus of claim 1, wherein the visual information extracting and converting unit extracts visual information including at least any one of a stage configuration scene, the object, and a layout of the object according to the result of text parsing.

4. The apparatus of claim 3, wherein the visual information extracting and converting unit converts the extracted visual information into a visualization script language.

5. The apparatus of claim 1, wherein the virtual space generating and object disposing unit generates the virtual space by using a predefined space template, and automatically generates at least any one of a ground and lighting of the virtual space.

6. The apparatus of claim 1, wherein virtual space generating and object disposing unit retrieves data matched to the visualization script language from a performance knowledge ontology database and a 3D graphic model object database, and outputs layout information of a virtual stage and a character.

7. The apparatus of claim 1, wherein the virtual performance stage output unit inputs the layout information of the virtual stage and the character to the virtual space received from the virtual space generating and object disposing unit, and outputs the generated virtual performance stage.

8. The apparatus of claim 1, wherein the simulation unit changes the layout of the object in scenes according to the received command, and performs stage management on the virtual space.

9. The apparatus of claim 1, wherein when editing information is received, the simulation unit retrieves information matched to the received editing information from the 3D graphic model object database, and edits a scene of the virtual performance stage.

10. The apparatus of claim 9, wherein the simulation unit provides a text editor, converts the editing information input in a language interface manner into a visualization script language by using the text editor, and edits a scene of the virtual performance stage.

11. A method for pre-visualizing text-based performance, the method comprising:
(a) parsing received text and outputting a result of text parsing;
(b) extracting visual information by using the result of text parsing, and converting the extracted visual information into a visualization script language;
(c) generating a virtual space and disposing an object; and
(d) outputting a virtual performance stage including the object, and performing performance simulation.

12. The method of claim 11, wherein step (a) includes receiving text regarding at least any one of a script and a performance scenario, and performing natural language processing on the received text to parse the received text.

13. The method of claim 11, wherein step (b) includes extracting visual information including at least any one of a stage configuration scene the object, and a layout of the object according to the result of text parsing, and converting the extracted visual information into a visualization script language.

14. The method of claim 11, wherein step (c) includes generating the virtual space by using a predefined space template, and automatically generating at least any one of a ground and lighting of the virtual space.

15. The method of claim 11, wherein step (c) includes retrieving data matched to the visualization script language from a performance knowledge ontology database and a 3D graphic model object database, and adding layout information of a stage and a character to the virtual space.

16. The method of claim 11, wherein step (d) includes directing the virtual performance stage by changing the layout of the object in scenes according to a received command.

17. The method of claim 16, wherein step (d) includes converting editing information input in a language interface manner through a text editor into a visualization script language, retrieving data matched to the converted visualization script language from the 3D graphic model object database to edit a scene of the virtual performance stage.
